(19) United States
(12) Patent Application Publication
(10) Pub. No.: US 2019/0380080 A1
(43) Pub. Date: Dec. 12, 2019

(54) First Core Network Node, Second Core Network Node, Radio Network Node, Wireless Device, and Methods Performed Thereby

(71) Applicant: Telefonaktiebolaget LM Ericsson (publ), Stockholm (SE)

(72) Inventors: Paul Schliwa-Bertling, Ljungsbro (SE); Markus Drevö, Linköping (SE); Thomas Walldeen, Linköping (SE); Peter Werner, Linköping (SE)

(21) Appl. No.: 16/462,328

(22) PCT Filed: Dec. 20, 2017
(86) PCT No.: PCT/SE2017/051301

§ 371 Date: May 20, 2019

Related U.S. Application Data
(60) Provisional application No. 62/438,674, filed on Dec. 23, 2016.

(51) Int. Cl. H04W 36/12; H04W 28/08; H04W 36/22; H04W 48/14

(52) U.S. Cl. CPC H04W 36/12; H04W 48/14; H04W 36/22; H04W 28/08

(57) ABSTRACT

Method performed by a first core network node (101). The first core network node (101) sends (301) first information relating to a wireless device (140) handled by the first core network node (101), to a second core network node (102). The sending (301) is performed in the absence of a request from the second core network node (102) to obtain the first information. The sending (301) of the first information initiates registration of the wireless device (140) with the second core network node (102). A method performed by the second core network node (102) receiving the first information is also disclosed, as well as a method performed by a radio network node (110) sending (504) a third message enabling registration of the wireless device (140) with the second core network node (102). A method performed by the wireless device (140) receiving the third message and accepting the registration is also described.

### TECHNICAL FIELD

The present disclosure relates generally to a first core network node and methods performed thereby for handling information relating to a wireless device. The present disclosure also relates generally to a second core network node and methods performed thereby for handling information relating to the wireless device. The present disclosure also relates generally to a radio network node and methods performed thereby for handling information relating to the wireless device. The present disclosure also relates generally to a wireless device and methods performed thereby for handling information relating to the wireless device.

### BACKGROUND

Communication devices within a wireless communications network may be e.g., stations (STAs), User Equipments (UEs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g. between two wireless devices, between a wireless device and a regular telephone, and/or between a wireless device and a server via a Radio Access Network (RAN), and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

Communication devices may be radio network nodes. A radio network node refers to any type of network node serving a User Equipment (UE) and/or connected to another network node or network element or any radio node from where a UE receives a signal. Examples of radio network nodes are Node B, Base Station (BS), Multi-Standard Radio (MSR) radio node such as MSR BS, eNode B, network controller, Radio Network Controller (RNC), base station controller, relay, donor node controlling relay, Base Transceiver Station (BTS), Access Point (AP), transmission points, transmission nodes, Remote Radio Unit (RRU), Remote Radio Head (RRH), nodes in Distributed Antenna System (DAS) etc. The wireless communications network covers a geographical area which may be divided into cell areas, each cell area being served by radio network node such as a Base Station (BS), e.g. a Radio Base Station (RBS), which sometimes may be referred to as e.g., evolved Node B (“eNB”), “eNodeB”, “NodeB”, “B node”, or BTS (Base Transceiver Station), depending on the technology and terminology used. The base stations may be of different classes such as e.g. Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The wireless communications network may also be a non-cellular system, comprising network nodes which may serve receiving nodes, such as wireless devices, with serving beams.

Communication devices may also be network nodes. The general term “network node” may correspond to any type of radio network node, as just described, or any network node, which communicates with at least a radio network node. Examples of network node are any radio network node stated above, core network node, e.g., Mobile Switching Centre (MSC), Mobility Management Entity (MME), etc. . . . , Operational and Maintenance (O&M), Operational Support Systems (OSS), Self Organizing Network (SON), positioning node, e.g., Evolved Serving Mobile Location Centre (E-SMLC), Minimization of Drive Test (MDT) etc.

In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station. 3GPP LTE radio access standard has been written in order to support high bitrates and low latency both for uplink and downlink traffic. All data transmission is in LTE controlled by the radio base station.

The standardization organization 3GPP is currently in the process of specifying a New Radio Interface called NR or 5G-UTRA, as well as a Fifth Generation (5G) Packet Core Network, which may be referred to as Next Generation Core Network (abbreviated as NG-CN, NGC or 5G CN). The current understanding of various concepts related to this work may be based on input from 3GPP TS 23.799 v1.1.0, and it is summarized below.

### Initial High Level Architectural View

FIG. 1 is a schematic representation of the current high level architecture of a system according to the Next Generation, also referred to as a Next Gen System. This high level architecture may be used as a reference model herein. FIG. 1 shows the NextGen UE, NextGen(R)AN, NextGen Core and their reference points.

If, and possibly how, the NextGen UE may interface with the NextGen Core is currently set for further study.

Reference points in the Next Gen System may be as follows:

NG2: Reference point for the control plane between NextGen (R)AN and NextGen Core.

NG3: Reference point for the user plane between NextGen (R)AN and NextGen Core.

NG1: Reference point for the control plane between NextGen UE and NextGen Core.

NG6: It is the reference point between the NextGen Core and the data network. Data network may be an operator external public or private data network or an intra-operator data network, e.g. for provision of Internet Protocol (IP) Multimedia Services (IMS) services. This reference point corresponds to SGi for 3GPP accesses.

The 5G RAN may comprise base stations supporting evolved LTE and/or New Radio (NR) radio access.

The 5G System is expected to support deployments in virtualized environments and introduce support for scaling of a network function instance; and dynamic addition or removal of a network function instance.

Load rebalancing and load migration may need to be performed in a 5G system. Load rebalancing may be understood as an action by the network to change a load among a set of nodes in order to utilize the resources in a better way. Load migration may be understood as moving the load from one node to another. Scaling may be understood as an ability of a system to adapt to changes, e.g., increases, in demands. Existing methods in LTE for load rebalancing or load migration, however, require signalling overhead for the UE involved when the load balancing or load migration is executed. This not only has negative repercussions on the capacity and latency of the network, which are respectively decreased and increased, but in addition, waste power resources, draining the battery of the UE involved.

### SUMMARY

It is an object of embodiments herein to improve the handling of a wireless device in a wireless communications network. It is a particular object of embodiments herein to improve the handling of a wireless device in a wireless communications network in relation to an execution of load balancing or load migration.

According to a first aspect of embodiments herein, the object is achieved by a method performed by a first core network node operating in a wireless communications network. The first core network node sends first information relating to a wireless device handled by the first core network node, to a second core network node. The second core network node operates in the wireless communications network. The sending is performed in the absence of a request from the second core network node to obtain the first information. The sending of the first information initiates registration of the wireless device with the second core network node.

According to a second aspect of embodiments herein, the object is achieved by a method performed by the second core network node operating in the wireless communications network. The second core network node receives from the first core network node operating in the wireless communications network, the first information associated with the wireless device handled by the first core network node. The wireless device operates in the wireless communications network. The receiving is performed in the absence of the request from the second core network node to obtain the first information. The receiving of the first information initiates registration of the wireless device with the second core network node.

According to a third aspect of embodiments herein, the object is achieved by a method performed by a radio network node operating in the wireless communications network. The radio network node serves the wireless device. The wireless device is handled by is first core network node. The first core network node and the wireless device operate in the wireless communications network. The radio network node sends a third message to the wireless device based on a second message received from the second core network node. The second core network node operates in the wireless communications network. The sending of the third message is performed in the absence of a requirement for signalling from the wireless device. The sending of the third message enables registration of the wireless device with the second core network node.

According to a fourth aspect of embodiments herein, the object is achieved by a method performed by the wireless device operating in the wireless communications network. The wireless device is handled by the first core network node operating in the wireless communications network. The wireless device receives the third message from the radio network node based on the second message sent from the second core network node. The second core network node and the radio network node operate in the wireless communications network. The receiving of the third message is performed in the absence of the requirement for signalling from the wireless device. The wireless device accepts registration with second core network node, based on the received third message.

According to a fifth aspect of embodiments herein, the object is achieved by the first core network node configured to operate in the wireless communications network. The first core network node is further configured to send the first information relating to the wireless device configured to be handled by the first core network node, to a second core network node. The second core network node is configured to operate in the wireless communications network. The sending is configured to be performed in the absence of the request from the second core network node to obtain the first information. The sending of the first information is configured to initiate registration of the wireless device with the second core network node.

According to a sixth aspect of embodiments herein, the object is achieved by the second core network node configured to operate in the wireless communications network. The second core network node is further configured to receive, from the first core network node configured to operate in the wireless communications network, the first information. The first information is associated with the wireless device configured to be handled by the first core network node. The wireless device is configured to operate in the wireless communications network. The receiving is configured to be performed in the absence of the request from the second core network node to obtain the first information. The receiving of the first information is configured to initiate registration of the wireless device with the second core network node.

According to a seventh aspect of embodiments herein, the object is achieved by the radio network node configured to operate in the wireless communications network. The radio network node is configured to serve the wireless device. The wireless device is configured to be handled by the first core network node. The first core network node and the wireless device are configured to operate in the wireless communications network. The radio network node is further configured to send the third message to the wireless device based on the second message configured to be received from the second core network node. The second core network node is configured to operate in the wireless communications network. To send the third message is configured to be performed in the absence of the requirement for signalling from the wireless device. The sending of the third message is configured to enable registration of the wireless device with the second core network node.

According to an eighth aspect of embodiments herein, the object is achieved by the wireless device configured to operate in the wireless communications network. The wireless device is configured to be handled by the first core network node configured to operate in the wireless communications network. The wireless device is further configured to receive the third message from the radio network node based on the second message configured to be sent from the second core network node. The second core network node and the radio network node are configured to operate in the wireless communications network. The receiving of the third message is configured to be performed in the absence of the requirement for signalling from the wireless device. The wireless device is further configured to accept registration with second core network node, based on the third message configured to be received.

By the first core network node transferring the first information associated the wireless device to the second core network node, in the absence of a request from the second core network node to obtain the first information, the overhead involved in load balancing and migration procedures in relation to the wireless device is reduced. Hence, the performance of the wireless communications network is improved, by reducing its latency and increasing its capacity. By the radio network node sending the third message to the wireless device in the absence of a requirement for signalling from the wireless device, wherein the sending of the third message enables registration of the wireless device with the second core network node, the overhead involved in load balancing and migration procedures in relation to the wireless device is also reduced. Moreover, battery consumption of the wireless device is reduced.

### BRIEF DESCRIPTION OF THE DRAWINGS

Examples of embodiments herein are described in more detail with reference to the accompanying drawings, and according to the following description.

FIG. 1 is a schematic diagram illustrating an initial high level architecture view for a NextGen System, according to existing methods.

FIG. 2 is a schematic diagram illustrating embodiments of a wireless communications network, according to embodiments herein.

FIG. 3 is a flowchart depicting embodiments of a method in a first core network node, according to embodiments herein.

FIG. 4 is a flowchart depicting embodiments of a method in a second core network node, according to embodiments herein.

FIG. 5 is a flowchart depicting embodiments of a method in a radio network node, according to embodiments herein.

FIG. 6 is a schematic diagram illustrating an example of embodiments of a method in a wireless device, according to embodiments herein.

FIG. 7 is a schematic diagram illustrating examples of different components of the wireless communications network and their interactions, according to embodiments herein.

FIG. 8 is a schematic diagram illustrating examples of different components of the wireless communications network and their interactions, according to embodiments herein.

FIG. 9 is a schematic diagram illustrating examples of different components of the wireless communications network and their interactions, according to embodiments herein.

FIG. 10 is a schematic block diagram illustrating embodiments of a first core network node, according to embodiments herein.

FIG. 11 is a schematic block diagram illustrating embodiments of a second core network node, according to embodiments herein.

FIG. 12 is a schematic block diagram illustrating embodiments of a radio network node, according to embodiments herein.

FIG. 13 is a schematic block diagram illustrating embodiments of a wireless device, according to embodiments herein.

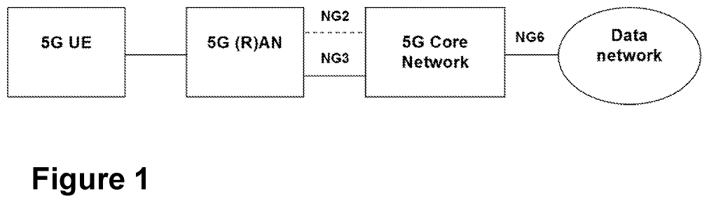

### DETAILED DESCRIPTION

As part of the development of embodiments herein, a problem in existing methods will first be identified and discussed.

When a Network Function (NF) is created, deleted, or moved, either within a data centre or between data centres, the Internet Protocol (IP) address used by a remote entity, e.g., 5G RAN node, Access Mobility Function (AMF), Session Management Function (SMF), User Plane Function (UPF), Subscriber Data Management (SDM), etc. . . . to route signalling/data to that NF may, or may not, change.

If the IP address of such a Network Function does change, then it may be beneficial that there is no need for UE interaction. If the network function and the UE share an identifier indicating the network function instance, this may have to be updated in the UE in order for the UE to indicate the correct destination of its messages. The need to avoid UE interaction may be understood to be in order to avoid: radio interface signalling load, UE battery consumption, and to handle cases where the UE is out of coverage or in Power Save Mode's/ Extended Discontinuous Reception (eDRX's) deep sleep state.

Another aspect is Load rebalancing and load migration across network function instances. The problem to be addressed is the required UE signalling overhead when Load rebalancing/migration is executed. In exiting methods, the first network function, for example, would need to change the identifier indicating the first network function to the identifier identifying the second network function over radio. For a UE in RRC IDLE, this would require paging, and then signalling for Globally Unique Temporary Identity (GUTI) reallocation in the case with an MME.

In order to address this problem, several embodiments are comprised herein. Embodiments herein may be understood to address the issue of the UE interaction from NF at Load Balancing, Scaling and Migration. Embodiments herein may also be understood to relate to UE management in a virtual environment. Embodiments herein provide methods to move UE(s) between Core Network (CN) instances without the need for signalling with the UE(s). Embodiments herein may therefore be understood to relate to Next Generation CN, 5G CN, NR, New RAN (5G-UTRAN), Registration, EPC, and 5G. Note that although terminology from 3GPP LTE has been used in this disclosure to exemplify the embodiments herein, this should not be seen as limiting the scope of the embodiments herein to only the aforementioned system. Other wireless systems, including WCDMA, WiMax, UMB and GSM, may also benefit from exploiting the ideas covered within this disclosure.

Embodiments will now be described more fully hereinafter with reference to the accompanying drawings, in which examples are shown. In this section, the embodiments herein will be illustrated in more detail by a number of exemplary embodiments. It should be noted that the exemplary embodiments herein are not mutually exclusive. Components from one embodiment may be tacitly assumed to be present in another embodiment and it will be obvious to a person skilled in the art how those components may be used in the other exemplary embodiments.

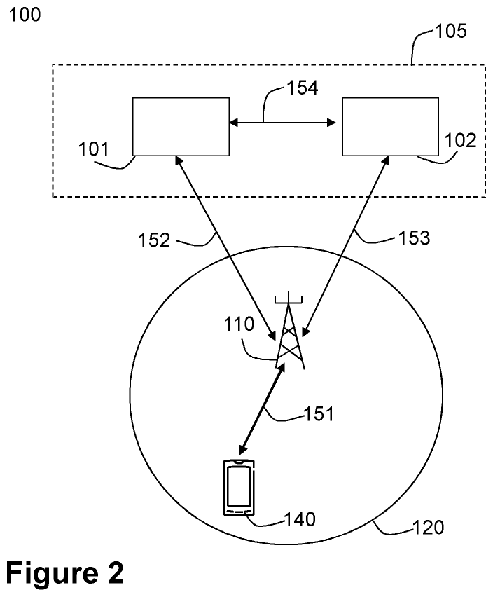

FIG. 2 depicts an example of a wireless communications network 100, sometimes also referred to as a wireless communications system, cellular radio system, or cellular network, in which embodiments herein may be implemented. The wireless communications network 100 may typically be a 5G system, 5G network, or Next Gen System or network. The wireless communications network 100 may support other technologies such as, for example, Long-Term Evolution (LTE), e.g. LTE Frequency Division Duplex (FDD), LTE Time Division Duplex (TDD), LTE Half-Duplex Frequency Division Duplex (HD-FDD), LTE operating in an unlicensed band, WCDMA, Universal Terrestrial Radio Access (UTRA) TDD, GSM network, GERAN network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. Thus, although terminology from 3GPP LTE may be used in this disclosure to exemplify embodiments herein, this should not be seen as limiting the scope of the embodiments herein to only the aforementioned system. The wireless communications network may also be a non-cellular system, comprising network nodes which may serve receiving nodes, such as wireless devices, with serving beams. This may be a typical case, e.g., a in a 5G network.

The wireless communications network 100 comprises a plurality of core network nodes, whereof a first core network node 101 and a second core network node 102 are depicted in FIG. 2. Each of the first core network node 101 and the second core network node 102 may be a core network node, such as a Mobility Management Entity (MME), an Operational and Maintenance (O&M), an Operational Support Systems (OSS), etc. . . . The first core network node 101 and the second core network node 102 are different core network nodes, which may be comprised in a first core network 105. Any of the first core network node 101 and the second core network node 102 may be a distributed node somewhere in the cloud.

The wireless communications network 100 comprises a plurality of radio network nodes, whereof a radio network node 110 is depicted in FIG. 2. The network node 110, may also be referred to herein as a network node 110. The radio network node 110 may be a transmission point such as a radio base station, for example a gNB, an eNB, an eNodeB, or an Home Node B, an Home eNode B or any other network node capable of serving a wireless device, such as a user equipment or a machine type communication device, in the wireless communications network 100.

The wireless communications network 100 covers a geographical area which may be divided into cell areas, wherein each cell area may be served by a radio network node, although, one radio network node may serve one or several cells. In the non-limiting example depicted in FIG. 2, the radio network node 110 serves a cell 120. In examples wherein the wireless communications network 100 may be a non-cellular system, the radio network node 110 may serve receiving nodes, such as wireless devices, with serving beams. The radio network node 110 may be of different classes, such as, e.g., macro eNodeB, home eNodeB or pico base station, based on transmission power and thereby also cell size. Typically, the wireless communications network 100 may comprise more cells similar to the cell 120, served by their respective radio network node. This is not depicted in FIG. 2 for the sake of simplicity. The radio network node 110 may support one or several communication technologies, and its name may depend on the technology and terminology used. In 3GPP LTE, the radio network node 110 may, which may be referred to as eNodeBs or even eNBs, may be directly connected to one or more core networks, such as the first core network 105.

A plurality of wireless devices is located in the wireless communication network 100, whereof a wireless device 140, is depicted in the non-limiting example of FIG. 2. The wireless device 140 comprised in the wireless communications network 100 may be a wireless communication device such as a 5G UE, or a UE, which may also be known as e.g., mobile terminal, wireless terminal and/or mobile station, a mobile telephone, cellular telephone, or laptop with wireless capability, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet computer, sometimes referred to as a surf plate with wireless capability, Machine-to-Machine (M2M) device, device equipped with a wireless interface, such as a printer or a file storage device, modem, or any other radio network unit capable of communicating over a wired or radio link in a communications system. The wireless device 140 comprised in the wireless communications network 100 is enabled to communicate wirelessly in the wireless communications network 100. The communication may be performed e.g., via a RAN, the first core network 105, and possibly the one or more core networks, which may comprised within the wireless communications network 100.

The radio network node 110 is a serving radio network node of the wireless device 140. The wireless device 140 is configured to communicate within the wireless communications network 100 with the radio network node 110 over a first link 151, e.g., a radio link. The radio network node 110 is configured to communicate within the wireless communications network 100 with the first core network node 101 over a second link 152, e.g., a radio link or a wired link. The radio network node 110 is configured to communicate within the wireless communications network 100 with the second core 10 network node 102 over a third link 153, e.g., a radio link or a wired link. The first core network node 101 is configured to communicate within the wireless communications network 100 with the second core network node 102 over a fourth link 154, e.g., a radio link or a wired link.

The first core network node 101 may be understood to be a first communication device, the second core network node 102 may be understood to be a second communication device, the radio network node 110 may be understood to be a third communication device, and the wireless device 140 may be understood to be a fourth communication device.

The first core network node 101 may be understood to be a first network node, the second core network node 102 may be understood to be a second network node, and the radio network node 110 may be understood to be a third network node.

In general, the usage of “first”, “second”, “third”, and/or “fourth”, etc. . . . herein may be understood to be an arbitrary way to denote different entities, and may be understood to not confer a cumulative or chronological character to the nouns they modify.

Several embodiments are comprised herein. Components from one embodiment may be tacitly assumed to be present in another embodiment and it will be obvious to a person skilled in the art how those components may be used in the other exemplary embodiments.

More specifically, the following are: a) embodiments related to a first communication device, e.g., a first network node or a first core network node, such as the first core network node 101; b) embodiments related to a second communication device, e.g., a second network node or a second core network node, such as the second core network node 102; c) embodiments related to a third communication device, e.g., a third network node or a radio network node, such as the radio network node 110; and d) embodiments related to a fourth communication device, e.g., a wireless device, such as the wireless device 140.

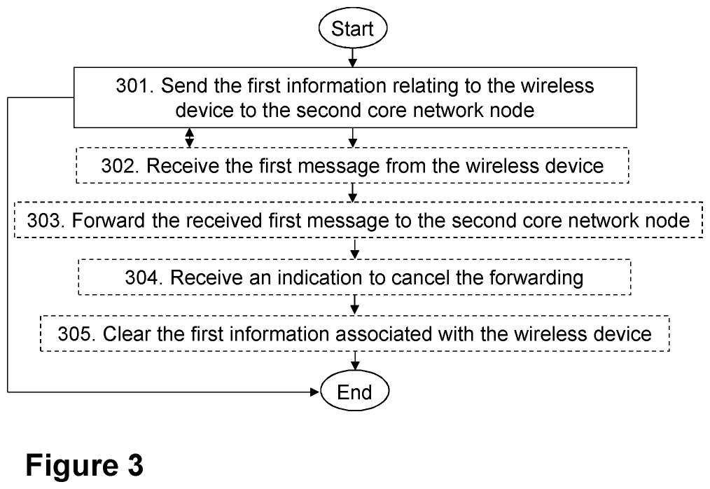

Embodiments of method performed by the first core network node 101, will now be described with reference to the flowchart depicted in FIG. 3. The first core network node 101 operates in the wireless communications network 100.

The method may comprise the actions described below. Several embodiments are comprised herein. In some embodiments all the actions may be performed. In some embodiments, one or more actions may be performed. One or more embodiments may be combined, where applicable. All possible combinations are not described to simplify the description. In some embodiments some of the actions may be performed. It should be noted that the examples herein are not mutually exclusive. In FIG. 3, optional actions are indicated with dashed lines.

### Action 301

The first core network node 101 may handle the wireless device 140. That is, the wireless device 140 may be registered with, or managed by the first core network node 101. At some point, the first core network node 101 may decide, for example, due to load balancing, to move the handling of the wireless device 140 to the second core network node 102. For this purpose, and to minimize the signalling with the wireless device 140, the first core network node 101, in this Action 301, sends, or transfers, first information relating to the wireless device 140 handled by the first core network node 101, to the second core network node 102 operating in the wireless communications network 100. The sending in this Action 301 is performed in the absence of a request from the second core network node 102 to obtain the first information. The sending 301 of the first information initiates registration of the wireless device 140 with the second core network node 102. This may enable the second core network node 102 to interact with the UE over the Non-access stratum (NAS). This Action 301 enables to avoid that the wireless device 140 may need to make an explicit registration again with the second network node 102, as in the existing methods, which would take extra time and in practice aborts any ongoing data transfer and service.

allows that in the ‘legacy way’ an UE can be passed to a new network node, but this leads to

That the first information relates to the wireless device 140 may also be understood as that the first information is associated with the wireless device 140.

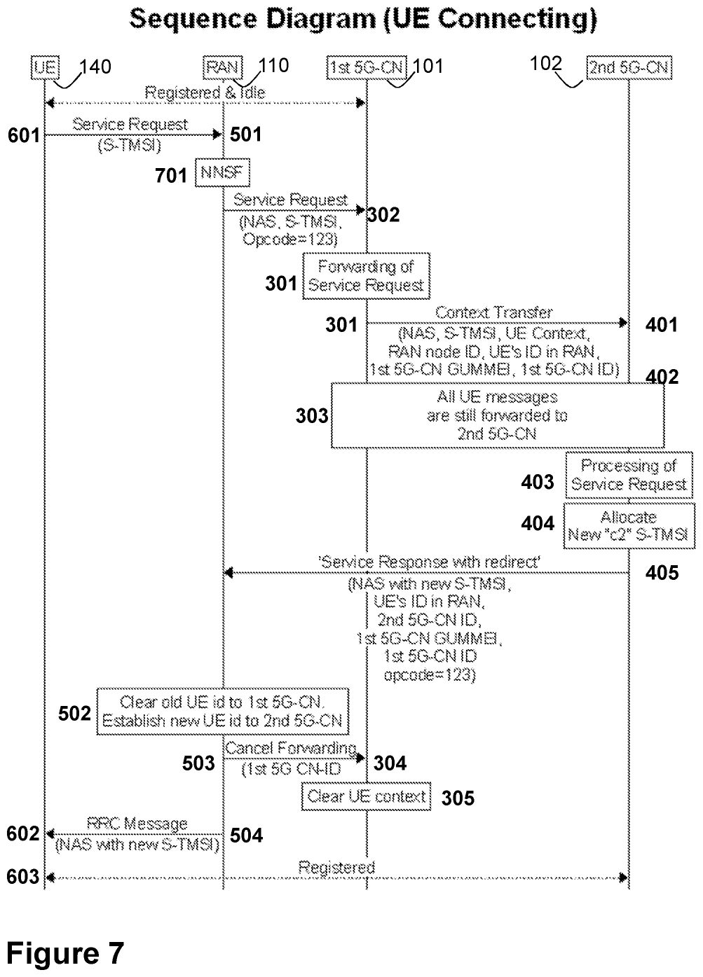

For example, in some embodiments, the first information may be a Mobility Management and Evolved Packet System, EPS, Context of a User Equipment, UE. This Action 301 may in fact be referred to herein as, e.g., a UE Context transfer procedure, e.g., related to Step 3 and Step 4, as described later in relation to FIG. 7.

The first information may comprise at least one of: a) a first identifier identifying a radio network node 110 serving the wireless device 140, such as a Radio Access Network (RAN) node Identifier (ID), or such as a global eNodeB identity in LTE, b) a second identifier identifying the wireless device 140 in a RAN, such as a UE's ID in RAN, or a UE S1AP IDs in LTE, c) a third identifier temporarily identifying the wireless device 140 in association with the first core network node 101, such as a first S-Temporary Mobile Subscriber Identity (S-TMSI), c) a fourth identifier identifying the first core network node 101 , e.g., with a globally unique identifier of the first core network node 101, such as a 1^{st} 5G-CN Globally Unique Mobility Management Entity Identifier (GUMMEI) or first GUMMEI, and e) a fifth identifier identifying the first core network node 101 in the first core network 105, such as a 1^{st} 5G-CN ID. S1AP, or S1-AP is the Application Protocol between MME and eNodeB.

The first core network node 101 may initiate the transferring in this Action 301 based on a load balancing decision or a migration decision, e.g., by the first core network node 101. The transferring 301 may be performed via an interface between the first core network node 101 and the second core network node 102, e.g., via the fourth link 154.

The transferring/sending in this Action 301 may be performed independently of receiving a first message from the wireless device 140.

Alternatively, the transferring/sending in this Action 301 may be performed based on receiving a first message from the wireless device 140, as described in the next Action 302. The first message may be a Non-Access Stratum (NAS) message.

### Action 302

In some embodiments, the first core network node 101 may, in this Action 302, receive the first message from the wireless device 140 via the radio network node 110 serving the wireless device 120. The radio network node 110 operates in the wireless communications network 100. The first message may comprise, or be associated with, the third identifier temporarily identifying the wireless device 140, e.g., in association with the first core network node 101, such as a first S-TMSI.

The receiving in this Action 302 may be performed over the first link 151 and the second link 152, each of which may be, e.g., a radio link or a wired link.

In some examples, the first information may comprise the received first message. The first message may be, for example, a request to send Mobile BroadBand (MBB) data or to make a ‘Tracking area update’.

### Action 303

The first message may be understood to comprise a ‘service request’, which may be understood to need to be served. To be able to serve the service request, the first message may not be lost and may be understood to need to be transferred to the second core network node 102, which may be understood to be now serving the wireless device 140. In order to enable the second network node 102 to serve the service request in the first message, and other potential messages received from the wireless device 140 before re-routing in the radio network node 110 is performed, in this Action 303, the first core network node 101 may forward, that is, send or re-direct, the received first message and any other messages received from wireless device 140, to the second core network node 102.

The forwarding in this Action 303 may be performed over the fourth link 154, e.g., a radio link or a wired link.

### Action 304

In this Action 304, the first core network node 101 may receive an indication to cancel the forwarding of Action 305, of the received first message and any other messages received from the wireless device 140, from the radio network node 110. From this point in time, the first network node 101 may then be understood to be enabled to release the signalling resources that may have been seized both for receiving messages from the radio network node 110 as well as forwarding messages to the second core network node 102.

The receiving in this Action 304 may be performed over the second link 152, e.g., a radio link or a wired link.

### Action 305

After performing Action 304, the first core network node 101, in this Action 305, may clear the first information associated with the wireless device 140, based on the received indication. That is, the first core network node 101 may clear the context of the wireless device 140. Hence, the the first core network node 101 may be understood to be enabled to release the resources connected to the context of the wireless device 140. That is, the wireless device 140 may be understood to be fully migrated to the second core network node 102.

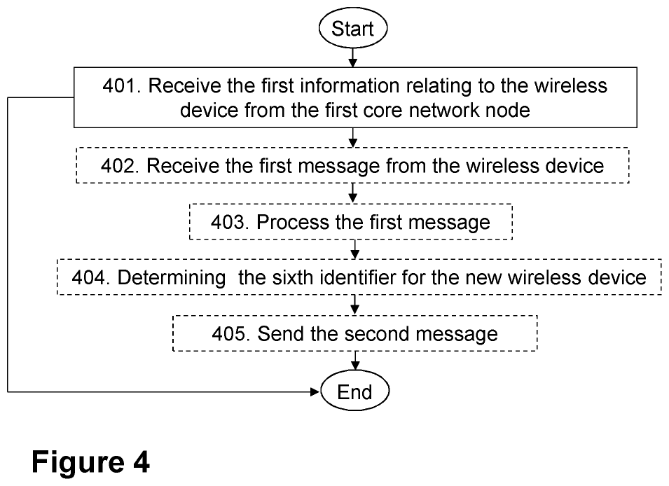

Embodiments of a method performed by the second core network node 102 operating in the wireless communications network 100, will now be described with reference to the flowchart depicted in FIG. 4. The method may be understood to be for handling information relating to the wireless device 140.

The method may comprise one or more of the following actions. In some embodiments all the actions may be performed. In some embodiments, one or more actions may be performed. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 4, optional actions are indicated with dashed lines.

The detailed description of some of the following corresponds to the same references provided above, in relation to the actions described for the first core network node 101, and will thus not be repeated here to simplify the description. For example, the first message may be a Non-Access Stratum (NAS) message.

### Action 401

The second core network node 102 in this Action 401, receives from the first core network node 101 operating in the wireless communications network 100, the first information associated with the wireless device 140 handled by the first core network node 101. As stated earlier, the wireless device 140 operates in the wireless communications network 100. Also as described earlier, that the wireless device 140 handled by the first core network node 101 may be understood as that it is registered with or managed by by the first core network node 101. The receiving in this Action 401 is performed in the absence of a request from the second core network node 102 to obtain the first information. The receiving 401 of the first information initiates registration of the wireless device 140 with the second core network node 102.

The receiving in this Action 401 may be performed over the fourth link 154, e.g., a radio link or a wired link.

In some examples, the first information may be a Mobility Management and Evolved Packet System (EPS) Context of a UE.

As described earlier, the first information may comprise at least one of: a) the first identifier, e.g., identifying the radio network node 110 serving the wireless device 140, such as a Radio Access Network (RAN) node Identifier (ID), or such as the global eNodeB identity in LTE, b) the second identifier, e.g., identifying the wireless device 140 in the RAN, such as the UE's ID in RAN, or a UE S1AP IDs in LTE, c) the third identifier, e.g., temporarily identifying the wireless device 140, e.g., in association with the first core network node 101, such as the first S-TMSI, d) the fourth identifier, e.g., identifying the first core network node 101, e.g., with the globally unique identifier of the first core network node 101, such as the 1^{st} 5G-CN GUMMEI or first GUMMEI, and e) the fifth identifier, e.g., identifying the first core network node 101 in the first core network 105, such as the 1^{st} 5G-CN ID.

The receiving 401 may be performed independently of receiving the first message from the wireless device 140.

Alternatively, the receiving 401 may be performed based on the first core network node 101 receiving the first message from the wireless device 140.

### Action 402

In this Action 402, the second core network node 102, may receive the first message from the wireless device 140, via the first core network node 101. The first message may comprise, or be associated with, the third identifier temporarily identifying the wireless device 140 in association with the first core network node 101, such as a first S-TMSI. As discussed before, the first message comprises a ‘service request’. The second core network node 102, after action 401, may be understood as having become the ‘service handler’ for this particular wireless device 140. To be able to complete the transfer of the wireless device 140 from the first core network node 101 to the second core network node 102 and still provide full service, these messages must be passed.

The receiving in this Action 302 may be performed over the first link 151, the second link 152, and the fourth link 154, each of which may be, e.g., a radio link or a wired link.

The first information may comprise the received first message.

### Action 403

In this Action 403, the second core network node 102 may process, based on the first information, the first message and any other messages received from wireless device 140 via the first core network node 101.

To process in this Action 403 may be understood as that the message sent in the service request is handled accordingly by the second core network node 102. That is, the first message is analyzed, and acted upon. The processing 403 may be based on the first information. That is, the information in the first message may be needed to generate the information provided to the wireless device 140 in Action 405. This Action 403 may be related to Step 5, as described later.

### Action 404

The second core network node 102 may, in this Action 404, determine 404 a sixth identifier, which may be understood as a new identifier. The sixth identifier may temporarily identify the wireless device 140 in association with the second core network node 102. This may enable the wireless device 140 to replace the old identifier, the third identifier, associating it with the first core network node 102 with this new identifier. After the wireless device 140 may replace its old identifier with the sixth identifier, further communication from the wireless device 140 may be directly routed to the second core network node 102, without having to first send the communication to the first core network node 101, and then have it forwarded to the second core network node 102.

Determining in this Action 404 may be understood as allocating or assigning.

The sixth identifier may be e.g., a second S-TMSI, or new S-TMSI. This Action 403 may be related to Step 6, as described later.

### Action 405

In this Action 405, the second core network node 102, may send a second message to the radio network node 110 serving the wireless device 140. The second message may be in response to the first message. The second message may comprise, or be associated with the determined identifier, that is, the determined or allocated sixth identifier.

The sending in this Action 405 may be performed over the third link 153, e.g., a radio link or a wired link.

The second message may be, e.g., a second response with redirect. The second message may be a NAS response message. This Action 405 may be related to Step 7, Step 8, and Step 9, as described later.

The second message may comprise second information. The second information may be associated with the wireless device 140. The second information may comprise at least one of: a) a seventh identifier, e.g., identifying the radio network node 110 serving the wireless device 140, such as a RAN node ID, or global eNodeB ID in LTE, b) an eighth identifier, e.g., identifying the wireless device 140 in a Radio Access Network RAN, such as a UE's ID in RAN, or UE S1AP IDs in LTE, and c) a ninth identifier, e.g., identifying the first core network node 101, e.g., with a globally unique identifier of the first core network node 101, such as a 1^{st} 5G-CN GUMMEI or first GUMMEI. The seventh identifier may be the same as the first identifier. The eighth identifier may be the same as the second identifier. The ninth identifier may be the same as the third identifier.

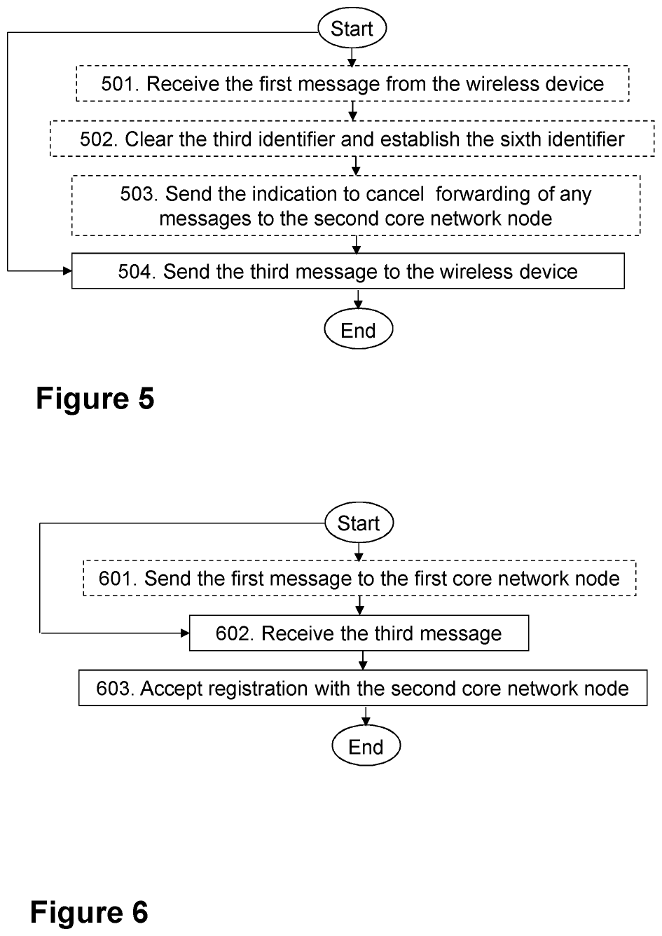

Embodiments of a method performed by the radio network node 110 operating in the wireless communications network 100, will now be described with reference to the flowchart depicted in FIG. 5. The method may be understood to be for handling information relating to the wireless device 140. The radio network node 110 serves the wireless device 140. The wireless device 140 is handled by the first core network node 101, which may be understood as that it may be registered with or managed by the first core network node 101. The first core network node 101 and the wireless device 140 operate in the wireless communications network 100.

The method may comprise one or more of the following actions. In some embodiments all the actions may be performed. In some embodiments, one or more actions may be performed. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 5, optional actions are indicated with dashed lines. The order of some actions may be changed, as for example illustrated in the non-limiting examples of FIGS. 7-9.

The detailed description of some of the following corresponds to the same references provided above, in relation to the actions described for the first core network node 101, and will thus not be repeated here to simplify the description. For example, the third identifier may be, e.g., the first S-TMSI.

### Action 501

The radio network node 110, in this Action 501, may receive the first message from the wireless device 140 directed to the first core network node 101. The first message may comprise, or be associated with, the third identifier temporarily identifying the wireless device 140 in association with the first core network node 101.

The receiving in this Action 501 may be performed over the first link 151, e.g., a radio link.

The received first message may be a NAS message.

### Action 502

In this Action 502, the radio network node 110, may clear the third identifier and establish the sixth identifier. The clearing in this Action 502 may be based on the received second message from the second core network node 102. This may allow subsequent messages during this connected session to be transferred directly to the second core network node 102, and not have to be first sent to the first core network node 101, and from to the first core network node 101 have them forwarded to the second core network node 102.

Establishing may be understood as e.g., selecting.

### Action 503

In this Action 503, the radio network node 110 may send the indication to the first core network node 101 to cancel the forwarding, or sending or re-directing, of any messages received from the wireless device 140 to the second core network node 102.

The sending in this Action 503 may be performed over the second link 152, e.g., a radio link or a wired link.

This Action 503 may be related to Step 9, as described later.

### Action 504

The radio network node 110, in this Action 504, sends a third message to the wireless device 140 based on the second message received from the second core network node 102. The second core network node 102 operates in the wireless communications network 100. The sending 504 of the third message is performed in the absence of a requirement for signalling from the wireless device 140. The sending in this Action 504 of the third message enables registration of the wireless device 140 with the second core network node 102.

The third message may comprise the sixth identifier temporarily identifying the wireless device 140 in association with the second core network node 102, such as a second S-TMSI. The third message may be a NAS message.

This Action 504 may be enable the wireless device 140, after the connected mode, to still be associated with the second core network node 102 and, hence, subsequent transitions from idle will go directly to the second core network node 102.

The method may further comprise receiving the second message from the second core network node 102. The second message may comprise or be associated with the second information. This Action 504 may be related to Step 10, as described later.

The method may comprise the radio network node 110 correlating the second message received from the second core network node 102 with a process it may have for the wireless device 140 towards/with the first core network node 101.

The sending in this Action 504 may be performed over the first link 151, e.g., a radio link.

Embodiments of a method performed by the wireless device 140 operating in the wireless communications network 100, will now be described with reference to the flowchart depicted in FIG. 6. The method may be understood to be for handling information relating to the wireless device 140. The wireless device 140 is handled, or registered with or managed by, by the first core network node 101 operating in the wireless communications network 100. The wireless device 140 may be served the radio network node 110.

The method may comprise one or more of the following actions. In some embodiments all the actions may be performed. In some embodiments, one or more actions may be performed. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 6, optional actions are indicated with dashed lines. The order of some actions may be changed, as for example illustrated in the non-limiting examples of FIGS. 7-9.

The detailed description of some of the following corresponds to the same references provided above, in relation to the actions described for the first core network node 101, and will thus not be repeated here to simplify the description. For example, the first message may be a NAS message.

### Action 601

The wireless device 140, when it may require a service from the wireless communications network 100, in this Action 601, may send the first message to the first core network node 101 via the radio network node 110. The first message may comprise, or may be associated with, the third identifier temporarily identifying the wireless device 140 in association with the first core network node 101, such as a first S-TMSI. This may be understood to be because at this point, the wireless device 140 does not know yet that the first core network node 101 has transferred its context to the second core network node 102.

The sending in this Action 601 may be performed over the first link 151, and the second link 152.

### Action 602

In this Action 602, the wireless device 140, receives the third message from the radio network node 110 based on the second message sent from the second core network node 102. The second core network node 102 and the radio network node 110 operate in the wireless communications network 100. The receiving 602 of the third message is performed in the absence of a requirement for signalling from the wireless device 140.

The receiving in this Action 602 may be performed over the first link 151.

The third message may comprise, or may be associated with the sixth identifier temporarily identifying the wireless device 140 in association with the second core network node 102, such as a second S-TMSI.

### Action 603

In this Action 603, the wireless device 140 accepts registration with second core network node 102, based on the received third message. The acceptance may be understood to mean that the identifiers provided may be used at next the communication with the second core network node 102 when coming from idle.

Embodiments herein may be based on several steps listed below, in reference to FIG. 7, which is a schematic diagram illustrating a non-limiting example of embodiments of different components of the wireless communications network 100 and their interactions, according to embodiments herein. The non-limiting example of FIG. 7 corresponds to the actions that may be performed by the different entities in the wireless communications network 100 when the wireless device 140 is taking contact with the wireless communications network 100. In FIG. 7, for the sake of illustration, 5G and LTE concepts and terminology are used. Hence, in the following description, any reference to a/the 1^{st} 5G-CN or first 5G-CN instance is understood to equally refer to the first core network node 101. Any reference herein to a/the 2^{nd} 5G-CN or second 5G-CN instance is understood to equally refer to the second core network node 102. Any reference herein to a/the RAN or RAN node is understood to refer to the radio network node 110. Any reference herein to a/the UE is understood to equally refer to the wireless device 140.

Initially, the UE is registered with the first 5G-CN and idle. As shown in FIG. 7, a first 5G-CN instance has been requested a service from a UE via a RAN node serving that UE, by means of a Non-Access Stratum (NAS) message, sent according to Action 601, and is being addressed by the UE e.g. through a temporary UE identifier that includes the address of the first 5G-CN instance, e.g. the S-Temporary Mobile Subscriber Identity (S-TMSI) in LTE. The first message, that is the NAS message, is received by the RAN node according to Action 501, which is then received by the first 5G-CN according to Action 302, after, at 701, a NAS Node Selection Function (NNSF) in the RAN node sends the first message to the first 5G-CN to provide the response to the UE.
1. The first 5G-CN instance decides e.g., due to load balancing to move the handling of that UE and handling of its request described by the NAS message to a second 5G-CN instance via a new 5G-CN interface between these 5G-CN instances.
2. The interaction between these two 5G-CN instances contains the transfer of the UE Context from the first 5G-CN instance to the second 5G-CN instance including the NAS message received from the UE.
3. In this UE Context transfer procedure, the first 5G-CN instance provides to the second 5G-CN instance, according to Action 301, the information required by the second 5G-CN instance to identify the RAN node serving the UE, in LTE this is the global eNodeB identity.
4. Additionally, based on the information received from the first 5G-CN instance according to Action 401, the second 5G-CN instance provides information ensuring the unambiguous identification of the UE in the RAN node serving the UE, e.g. UE's RAN node address, in LTE, this is the UE eNodeB S1AP address and the information identifying the S1AP interface by the identity of the CN instance, i.e., the Globally Unique MME Identifier (GUMMED.
5. The second 5G-CN instance processes, according to Action 403, the request from the UE received in the NAS information, according to Action 402, taking the UE Context information into the considerations.
6. To ensure that subsequent requests/messages from that UE forwarded by the first 5G-CN according to Action 303, i.e. all subsequent handling of that UE related to the CN specific functions is handled by the second 5G-CN instance, it assigns a new temporary identifier to that UE that includes the address of that second 5G-CN instance used by the RAN nodes at NAS-Node Selection Function (N NSF) when routing NAS messages to the CN, according to Action 404.
7. The second 5G-CN instance, according to Action 405, replies back to the UE via the UE serving RAN node using the information about the UE serving RAN node received in step 3 from the first 5G-CN instance.
8. In the 5G-CN to RAN control plane message containing the NAS response to the UE, the second 5G-CN instance includes an indication that this message is a response to a procedure initiated by the RAN node to the first 5G-CN instance. It may indicate a procedure identifier, e.g. a specific transaction identity if that was provided by the first 5G-CN instance in previous steps.
9. Additionally, the 5G-CN to RAN control plane message containing the NAS response message to the UE, includes the information that enables the UE serving RAN node to unambiguously identify the initial procedure with the first 5G-CN instance to which the message received in step 7 from the second 5G-CN instance constitutes the response. This unambiguous identification may be based on the information received from the first 5G-CN instance, e.g. UE's RAN node address, in LTE this is the UE eNodeB S1AP address and the information identifying the S1AP interface by the identity of the CN instance, i.e. the GUMMEI, used by the RAN node at initial procedure/sending the NAS message to the first 5G-CN instance. The RAN node then changes so that subsequent messages from the UE or RAN node related to this connection are from now on sent to the second 5G-CN instance. According to Action 502, the RAN node clears the third identifier, the old UE identifier, and establishes the sixth identifier. Hence no connection is established towards the first 5G-CN instance, it is moved to be established towards the second 5G-CN instance instead. According to Action 503, the RAN node sends the indication to the first 5G-CN to cancel forwarding of any messages received from the UE to the second 5G-CN. The indication is received by the first 5G-CN according to Action 304, and the first 5G-CN clears the UE context according to Action 305.
10. The UE serving RAN node sends the NAS message to the UE over the appropriate radio channel in a Radio Resource Control (RRC) message, according to Action 504, which is received by the UE, according to Action 602. According to Action 603, the UE accepts registration with the second 5G-CN.

In some examples, performance of the registration process and context transfer according to embodiments herein, may be carried out based on the LTE specification TS 23.401 v14.2.0, section 5.3.3.1. Tracking Area Update procedure with Serving GW change. In steps 4 and 5, the context may be transferred between the CN nodes.

In some examples, the content of the context transfer according to embodiments herein may be based on the LTE specification TS 29.274 v14.2.0, section 7.3.6 Context Response.

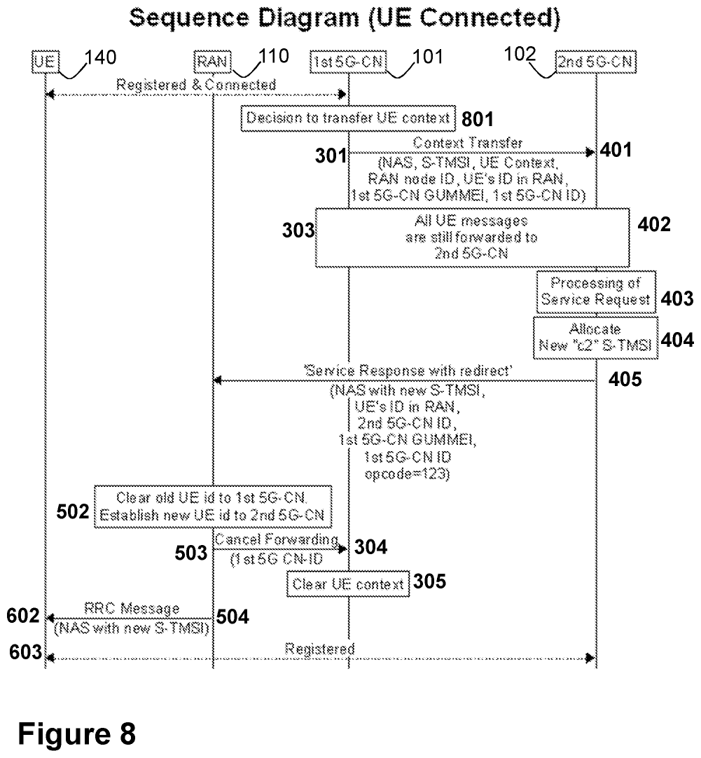

FIG. 8 is a schematic diagram illustrating another non-limiting example of embodiments of different components of the wireless communications network and their interactions, according to embodiments herein. The terminology used is similar to that of FIG. 7, and so are the actions, the description of which will not be repeated here. In this particular example, the UE is in connected state. Initially, the UE is registered with the first 5G-CN and connected. The first 5G-CN decides, at 801, to transfer the UE context independently of receiving the first message from the UE. The “Service Response with redirect” in this case is not necessarily a response to a service request.

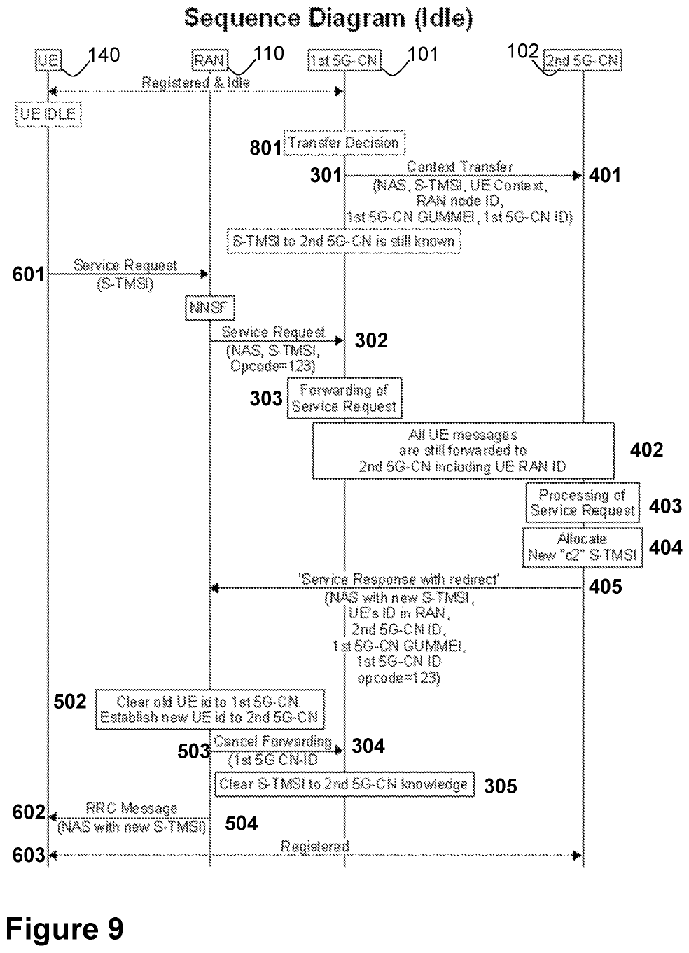

FIG. 9 is a schematic diagram illustrating yet another non-limiting example of embodiments of different components of the wireless communications network and their interactions, according to embodiments herein. The terminology used is similar to that of FIG. 7, and so are the actions, the description of which will not be repeated here. In this particular example, the UE is in idle state. Initially, the UE is registered with the first 5G-CN and idle. The first 5G-CN decides, at 801, to transfer the UE context independently of receiving the first message from the UE. In this example, when according to Action 302 the first 5G-CN receives the first message that has been sent by the UE, the S-TMSI to the second 5G-CN is still unknown. This may be understood as that the UE context is transferred from the first 5G-CN to the second 5G-CN, but the UE is not informed, that is, S-TMSI to second CN node is unknown, and at subsequent contact, the UE will be routed to the first 5G-CN.

In an alternative example to that depicted in FIG. 9 the method may be performed with some changes. The second 5G-CN may allocate a new Globally Unique Temporary Identity (GUTI), that is, new with respect to the existing S-TMSI. It may be understood that the GUTI comprises the S-TMSI. This new GUTI may not be included in the service response with re-direct of Action 405. Then, instead of the RAN node cancelling the forwarding to the first 5G-CN, the RAN node may clear the S1 AP connection to the first 5G-CN. The subsequent RRC message from the RAN node to the UE may comprise the service request response. The UE may then be connected and registered to the second 5G-CN, which may include other possible messages from the UE. However, the first 5G-CN may still forward new establishments, that is service requests, since the GUTI is not yet re-allocated at the UE, although it may have been at the 5G-CNs. The second 5G-CN may at some point transfer the downlink NAS message with the GUTI reallocation Command (Cmd) with the new GUTI to the RAN node. The RAN node may the send an RRC message to the UE with the NAS and the GUTI reallocation Cmd with the new GUTI. The RAN node additionally sends another RRC message with the NAS and the GUTI reallocation Complete (Compl) with the new GUTI. The RAN node may then send a message to the second 5G-CN indicating the transfer of the uplink NAS message, comprising the NAS, and the GUTI reallocation Compl with the new GUTI. The second 5G-CN may then instruct the first 5G-CN to cancel the forwarding, including the CN-ID to the UE context in the first 5G-CN. The first 5G-CN may the clear the GUTI to the second 5G-CN knowledge. Therefore, the first 5G-CN may now “forget” the whole UE context, as well as any related knowledge to the 2nd 5G-CN.

One advantage of embodiments herein is that the methods described enable the possibility to handle moving a UE during load rebalancing and load migration across network function instances, avoiding signalling with the UE.

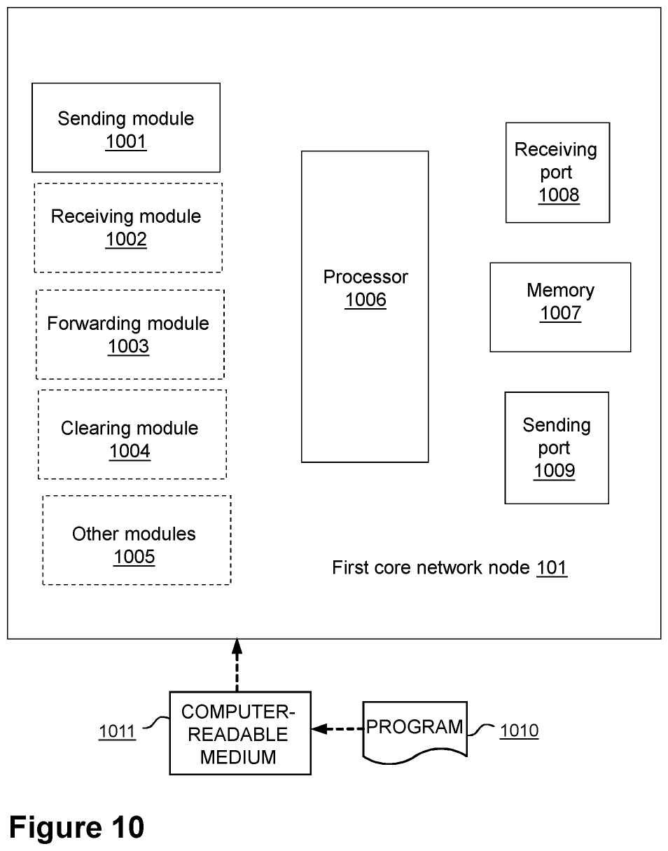

To perform the method actions described above in relation to FIG. 3, and FIGS. 7-9, The first core network node 101 may comprise the following arrangement depicted in FIG. 10. The first core network node 101 is configured to operate in a wireless communications network 100.

The detailed description of some of the following corresponds to the same references provided above, in relation to the actions described for the first core network node 101, and will thus not be repeated here. For example, the first message may be a NAS message.

It should be noted that the examples herein are not mutually exclusive. Components from one example may be tacitly assumed to be present in another example and it will be obvious to a person skilled in the art how those components may be used in the other examples. In FIG. 10, optional modules are indicated with dashed boxes.

The first core network node 101 is configured to perform the transferring or sending Action 301, e.g. by means of a sending module 1001 within the first core network node 101 configured to, send the first information relating to the wireless device 140 configured to be handled by the first core network node 101, to the second core network node 102 configured to operate in the wireless communications network 100. The sending is configured to be performed in the absence of the request from the second core network node 102 to obtain the first information. The sending of the first information is configured to initiate registration of the wireless device 140 with the second core network node 102. The sending module 1001 may be a processor 1006 of the first core network node 101, or an application running on such processor.

In some embodiments, the first information may be a Mobility Management and Evolved Packet System (EPS) Context of a UE.

In some embodiments, the first information may be configured to comprise at least one of: a) the first identifier configured to identify the radio network node 110 configured to serve the wireless device 140, b) the second identifier configured to identify the wireless device 140 in the RAN, c) the third identifier configured to temporarily identify the wireless device 140 in association with the first core network node 101, c) the fourth identifier configured to identify the first core network node 101, and e) the fifth identifier configured to identify the first core network node 101 in the first core network 105.

In some embodiments, to send may be configured to be performed independently of receiving the first message from the wireless device 140.

In other embodiments, to send may be configured to be performed based on receiving a first message from the wireless device 140.

The first core network node 101 may be configured to perform the receiving action 302, e.g. by means of a receiving module 1002 within the first core network node 101 configured to, receive the first message from the wireless device 140 via the radio network node 110 configured to serve the wireless device 120, the radio network node 110 being configured to operate in the wireless communications network 100. The first message may be configured to comprise the third identifier temporarily identifying the wireless device 140. The receiving module 1002 may be the processor 1006 of the first core network node 101, or an application running on such processor.

The first core network node 101 may be configured to perform the forwarding action 303, e.g. by means of a forwarding module 1003 within the first core network node 101 configured to, forward the first message configured to be received and any other messages configured to be received from wireless device 140, to the second core network node 102. The forwarding module 1003 may be the processor 1006 of the first core network node 101, or an application running on such processor.

In some embodiments, the first core network node 101 may be configured to perform the receiving action 304, e.g. by means of the receiving module 1002 configured to receive the indication to cancel the forwarding of the first message configured to be received and any other messages configured to be received from the wireless device 140 from the radio network node 110.

The first core network node 101 may be configured to perform the clearing action 505, e.g. by means of a clearing module 1004 within the first core network node 101 configured to, clear the first information associated with the wireless device 140, based on the indication configured to be received. The clearing module 1004 may be the processor 1006 of the first core network node 101, or an application running on such processor.

Other modules 1005 may be comprised in the first core network node 101.

The embodiments herein may be implemented through one or more processors, such as a processor 1006 in the first core network node 101 depicted in FIG. 10, together with computer program code for performing the functions and actions of the embodiments herein. The program code mentioned above may also be provided as a computer program product, for instance in the form of a data carrier carrying computer program code for performing the embodiments herein when being loaded into the in the first core network node 101. One such carrier may be in the form of a CD ROM disc. It is however feasible with other data carriers such as a memory stick. The computer program code may furthermore be provided as pure program code on a server and downloaded to the first core network node 101.

The first core network node 101 may further comprise a memory 1007 comprising one or more memory units. The memory 1007 is arranged to be used to store obtained information, store data, configurations, schedulings, and applications etc. to perform the methods herein when being executed in the first core network node 101.

In some embodiments, the first core network node 101 may receive information from the second core network node 102, the radio network node 110 and/or the wireless device 140, through a receiving port 1008. In some embodiments, the receiving port 1008 may be, for example, connected to one or more antennas in first core network node 101. In other embodiments, the first core network node 101 may receive information from another structure in the wireless communications network 100 through the receiving port 1008. Since the receiving port 1008 may be in communication with the processor 1006, the receiving port 1008 may then send the received information to the processor 1006. The receiving port 1008 may also be configured to receive other information.

The processor 1006 in the first core network node 101 may be further configured to transmit or send information to e.g., the second core network node 102, the radio network node 110 and/or the wireless device 140, through a sending port 1009, which may be in communication with the processor 1006, and the memory 1007.

Those skilled in the art will also appreciate that the sending module 1001, the receiving module 1002, the forwarding module 1003, the clearing module 1004, and the other modules 1005 described above may refer to a combination of analog and digital modules, and/or one or more processors configured with software and/or firmware, e.g., stored in memory, that, when executed by the one or more processors such as the processor 1006, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different modules 1001-1005 described above may be implemented as one or more applications running on one or more processors such as the processor 1006.

Thus, the methods according to the embodiments described herein for the first core network node 101 may be respectively implemented by means of a computer program 1010 product, comprising instructions, i.e., software code portions, which, when executed on at least one processor 1006, cause the at least one processor 1006 to carry out the actions described herein, as performed by the first core network node 101. The computer program 1010 product may be stored on a computer-readable storage medium 1011. The computer-readable storage medium 1011, having stored thereon the computer program 1010, may comprise instructions which, when executed on at least one processor 1006, cause the at least one processor 1006 to carry out the actions described herein, as performed by the first core network node 101. In some embodiments, the computer-readable storage medium 1011 may be a non-transitory computer-readable storage medium, such as a CD ROM disc, a memory stick, or stored in the cloud space. In other embodiments, the computer program 1010 product may be stored on a carrier containing the computer program, wherein the carrier is one of an electronic signal, optical signal, radio signal, or the computer-readable storage medium 1011, as described above.

The first core network node 101 may comprise an interface unit to facilitate communications between the first core network node 101 and other nodes or devices, e.g., the second core network node 102, the radio network node 110, the wireless device 140, or any of the other nodes. In some particular examples, the interface may, for example, include a transceiver configured to transmit and receive radio signals over an air interface in accordance with a suitable standard.

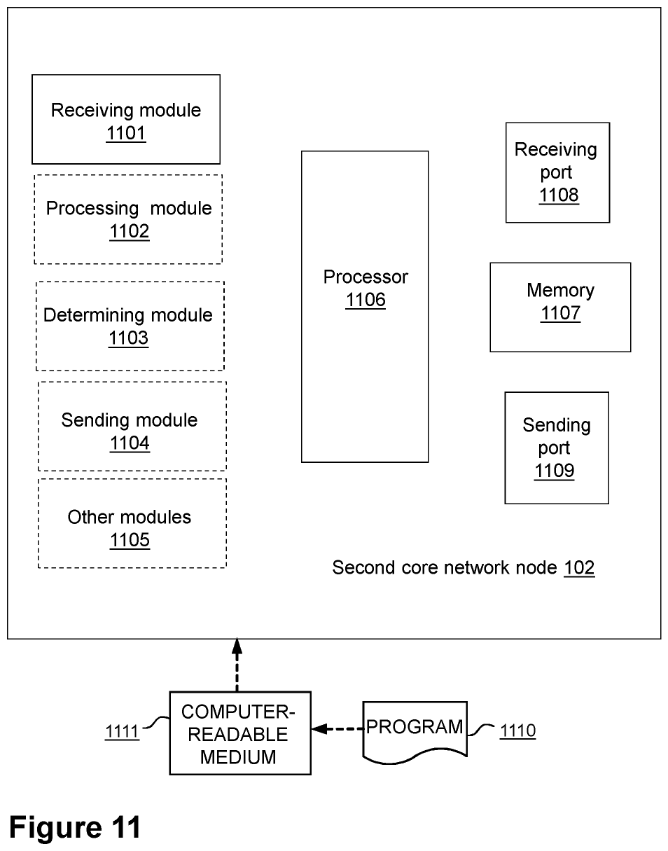

The second core network node 102 may comprise the following arrangement depicted in FIG. 11.

To perform the method actions described above in relation to FIG. 4, and FIGS. 7-9, the second core network node 102 may comprise the following arrangement depicted in FIG. 11. The second core network node 102 is configured to operate in the wireless communications network 100.

It should be noted that the examples herein are not mutually exclusive. Components from one example may be tacitly assumed to be present in another example and it will be obvious to a person skilled in the art how those components may be used in the other examples. In FIG. 11, optional modules are indicated with dashed boxes.

The detailed description of some of the following corresponds to the same references provided above, in relation to the actions described for the second core network node 102, and will thus not be repeated here. For example, the first message may be a NAS message.

The second core network node 102 is configured to perform the receiving action 401, e.g. by means of a receiving module 1101 within the second core network node 102 configured to, receive, from the first core network node 101 configured to operate in the wireless communications network 100, the first information associated with the wireless device 140 configured to be handled by the first core network node 101. The wireless device 140 is configured to operate in the wireless communications network 100. The receiving is configured to be performed in the absence of the request from the second core network node 102 to obtain the first information. The receiving of the first information is configured to initiate registration of the wireless device 140 with the second core network node 102. The receiving module 1101 may be a processor 1106 of the second core network node 102, or an application running on such processor.

In some embodiments, the second core network node 102 may be configured to perform the receiving action 402, e.g. by means of the receiving module 1001 within the second core network node 102 further configured to, receive the first message from the wireless device 140, via the first core network node 101. The first message may be configured to comprise the third identifier temporarily identifying the wireless device 140 in association with the first core network node 101.

The second core network node 102 may be configured to perform the processing action 403, e.g. by means of a processing module 1102 within the second core network node 102 configured to, process, based on the first information, the first message and any other messages configured to be received from wireless device 140 via the first core network node 101. The processing module 1102 may be the processor 1106 of the second core network node 102, or an application running on such processor.

The second core network node 102 may be configured to perform the determining action 404, e.g. by means of a determining module 1103 within the second core network node 102 configured to, determine the sixth identifier, the sixth identifier being configured to temporarily identify the wireless device 140 in association with the second core network node 102. The determining module 1103 may be the processor 1106 of the second core network node 102, or an application running on such processor.

The second core network node 102 may be configured to perform the sending action 405, e.g. by means of a sending module 1104 within the second core network node 102 configured to, send the second message to the radio network node 110 configured to serve the wireless device 140. The second message may be in response to the first message. The second message may be associated with the identifier configured to be determined. The sending module 1104 may be the processor 1106, or an application running on such processor. The second message may be directed to the wireless device 140.

In some embodiments, the second message may be configured to comprise second information associated with the wireless device 140. The second information may be configured to comprise at least one of: a) the seventh identifier configured to identify the radio network node 110 configured to serve the wireless device 140, b) the eighth identifier configured to identify the wireless device 140 in the RAN, and c) the ninth identifier configured to identify the first core network node 101.

Other modules 1105 may be comprised in the second core network node 102.

The embodiments herein may be implemented through one or more processors, such as a processor 1106 in the second core network node 102 depicted in FIG. 11, together with computer program code for performing the functions and actions of the embodiments herein. The program code mentioned above may also be provided as a computer program product, for instance in the form of a data carrier carrying computer program code for performing the embodiments herein when being loaded into the in the second core network node 102. One such carrier may be in the form of a CD ROM disc. It is however feasible with other data carriers such as a memory stick. The computer program code may furthermore be provided as pure program code on a server and downloaded to the second core network node 102.

The second core network node 102 may further comprise a memory 1107 comprising one or more memory units. The memory 1107 is arranged to be used to store obtained information, store data, configurations, schedulings, and applications etc. to perform the methods herein when being executed in the second core network node 102.

In some embodiments, the second core network node 102 may receive information from the first core network node 101, the radio network node 110 and/or the wireless device 140, through a receiving port 1108. In some embodiments, the receiving port 1108 may be, for example, connected to one or more antennas in second core network node 102. In other embodiments, the second core network node 102 may receive information from another structure in the wireless communications network 100 through the receiving port 1108. Since the receiving port 1108 may be in communication with the processor 1106, the receiving port 1108 may then send the received information to the processor 1106. The receiving port 1108 may also be configured to receive other information.

The processor 1106 in the second core network node 102 may be further configured to transmit or send information to e.g., the first core network node 101, the radio network node 110 and/or the wireless device 140, through a sending port 1109, which may be in communication with the processor 1106, and the memory 1107.

Those skilled in the art will also appreciate that the receiving module 1101, the processing module 1102, the determining module 1103, the sending module 1104, and the other modules 1105 described above may refer to a combination of analog and digital modules, and/or one or more processors configured with software and/or firmware, e.g., stored in memory, that, when executed by the one or more processors such as the processor 1106, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different modules 1101-1105 described above may be implemented as one or more applications running on one or more processors such as the processor 1106.

Thus, the methods according to the embodiments described herein for the second core network node 102 may be respectively implemented by means of a computer program 1110 product, comprising instructions, i.e., software code portions, which, when executed on at least one processor 1106, cause the at least one processor 1106 to carry out the actions described herein, as performed by the second core network node 102. The computer program 1110 product may be stored on a computer-readable storage medium 1111. The computer-readable storage medium 1111, having stored thereon the computer program 1110, may comprise instructions which, when executed on at least one processor 1106, cause the at least one processor 1106 to carry out the actions described herein, as performed by the second core network node 102. In some embodiments, the computer-readable storage medium 1111 may be a non-transitory computer-readable storage medium, such as a CD ROM disc, a memory stick, or stored in the cloud space. In other embodiments, the computer program 1110 product may be stored on a carrier containing the computer program, wherein the carrier is one of an electronic signal, optical signal, radio signal, or the computer-readable storage medium 1111, as described above.

The second core network node 102 may comprise an interface unit to facilitate communications between the second core network node 102 and other nodes or devices, e.g., the first core network node 101, the radio network node 110, the wireless device 140, or any of the other nodes. In some particular examples, the interface may, for example, include a transceiver configured to transmit and receive radio signals over an air interface in accordance with a suitable standard.

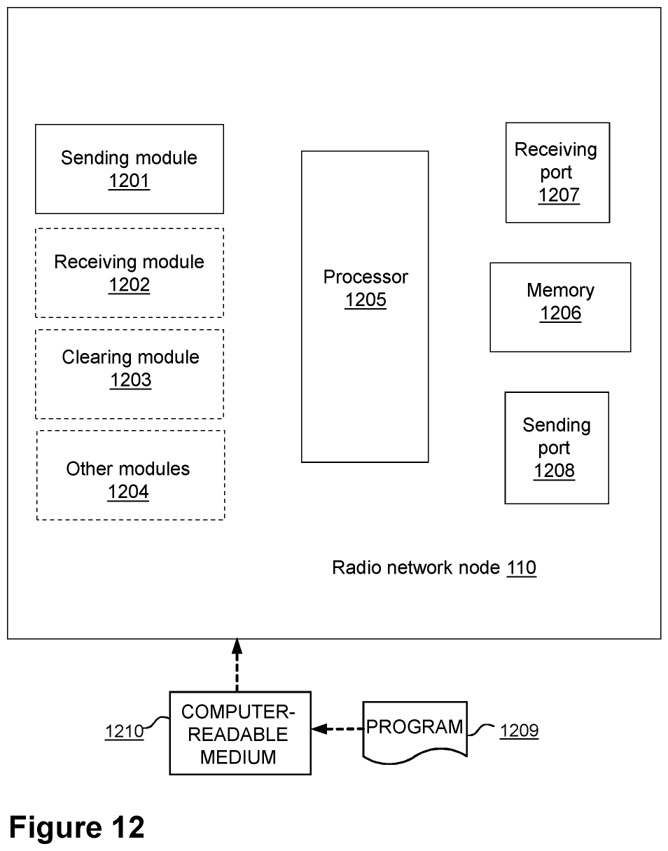

To perform the method actions described above in relation to FIG. 5, and FIGS. 7-9, the radio network node 110 may comprise the following arrangement depicted in FIG. 12. The radio network node 110 is configured to operate in the wireless communications network 100. The radio network node 110 is configured to serve the wireless device 140. The wireless device 140 is configured to be handled by the first core network node 101. The first core network node 101 and the wireless device 140 are configured to operate in the wireless communications network 100.

The detailed description of some of the following corresponds to the same references provided above, in relation to the actions described for the radio network node 110, and will thus not be repeated here. For example, the first message may be a NAS message.

It should be noted that the examples herein are not mutually exclusive. Components from one example may be tacitly assumed to be present in another example and it will be obvious to a person skilled in the art how those components may be used in the other examples. In FIG. 12, optional modules are indicated with dashed boxes.

The radio network node 110 may be configured to perform the sending action 504, e.g. by means of a sending module 1201 within the radio network node 110 configured to, send the third message to the wireless device 140 based on the second message configured to be received from the second core network node 102. The second core network node 102 is configured to operate in the wireless communications network 100. To send the third message is configured to be performed in the absence of the requirement for signalling from the wireless device 140. The sending of the third message is configured to enable registration of the wireless device 140 with the second core network node 102. The sending module 1201 may be a processor 1205 of the radio network node 110, or an application running on such processor.

The radio network node 110 may be configured to perform the receiving action 501, e.g. by means of a receiving module 1202 within the radio network node 110 configured to, receive the first message from the wireless device 140 configured to be directed to the first core network node 101. The first message may be configured to comprise the third identifier temporarily identifying the wireless device 140 in association with the first core network node 101. The third message may be configured to comprise the sixth identifier temporarily identifying the wireless device 140 in association with the second core network node 102. The receiving module 1202 may be the processor 1205 of the radio network node 110, or an application running on such processor.

The radio network node 110 may be configured to perform the clearing action 502, e.g. by means of a clearing module 1203 within the radio network node 110 configured to, clear the third identifier and establish the sixth identifier. The clearing may be configured to be based on the second message configured to be received from the second core network node 102. The clearing module 1203 may be the processor 1205 of the radio network node 110, or an application running on such processor.

The radio network node 110 may be configured to perform the sending action 503, e.g. by means the sending module 1201 further configured to, send the indication to the first core network node 101 to cancel forwarding of any messages configured to be received from the wireless device 140 to the second core network node 102.

Other modules 1204 may be comprised in the radio network node 110.

The embodiments herein may be implemented through one or more processors, such as a processor 1205 in the radio network node 110 depicted in FIG. 12, together with computer program code for performing the functions and actions of the embodiments herein. The program code mentioned above may also be provided as a computer program product, for instance in the form of a data carrier carrying computer program code for performing the embodiments herein when being loaded into the in the radio network node 110. One such carrier may be in the form of a CD ROM disc. It is however feasible with other data carriers such as a memory stick. The computer program code may furthermore be provided as pure program code on a server and downloaded to the radio network node 110.

The radio network node 110 may further comprise a memory 1206 comprising one or more memory units. The memory 1206 is arranged to be used to store obtained information, store data, configurations, schedulings, and applications etc. to perform the methods herein when being executed in the radio network node 110.

In some embodiments, the radio network node 110 may receive information from the first core network node 101, the second core network node 102 and/or the wireless device 140, through a receiving port 1207. In some embodiments, the receiving port 1207 may be, for example, connected to one or more antennas in radio network node 110. In other embodiments, the radio network node 110 may receive information from another structure in the wireless communications network 100 through the receiving port 1207. Since the receiving port 1207 may be in communication with the processor 1205, the receiving port 1207 may then send the received information to the processor 1205. The receiving port 1207 may also be configured to receive other information.

The processor 1205 in the radio network node 110 may be further configured to transmit or send information to e.g., the radio network node 110, the second core network node 102 and/or the wireless device 140, through a sending port 1208, which may be in communication with the processor 1205, and the memory 1206.

Those skilled in the art will also appreciate that the sending module 1201, the receiving module 1202, the clearing module 1203, and the other modules 1204 described above may refer to a combination of analog and digital modules, and/or one or more processors configured with software and/or firmware, e.g., stored in memory, that, when executed by the one or more processors such as the processor 1205, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different modules 1201-1204 described above may be implemented as one or more applications running on one or more processors such as the processor 1205.

Thus, the methods according to the embodiments described herein for the radio network node 110 may be respectively implemented by means of a computer program 1209 product, comprising instructions, i.e., software code portions, which, when executed on at least one processor 1205, cause the at least one processor 1205 to carry out the actions described herein, as performed by the radio network node 110. The computer program 1209 product may be stored on a computer-readable storage medium 1210. The computer-readable storage medium 1210, having stored thereon the computer program 1209, may comprise instructions which, when executed on at least one processor 1205, cause the at least one processor 1205 to carry out the actions described herein, as performed by the radio network node 110. In some embodiments, the computer-readable storage medium 1210 may be a non-transitory computer-readable storage medium, such as a CD ROM disc, a memory stick, or stored in the cloud space. In other embodiments, the computer program 1209 product may be stored on a carrier containing the computer program, wherein the carrier is one of an electronic signal, optical signal, radio signal, or the computer-readable storage medium 1210, as described above.

The radio network node 110 may comprise an interface unit to facilitate communications between the radio network node 110 and other nodes or devices, e.g., the radio network node 110, the second core network node 102, the wireless device 140, or any of the other nodes. In some particular examples, the interface may, for example, include a transceiver configured to transmit and receive radio signals over an air interface in accordance with a suitable standard.

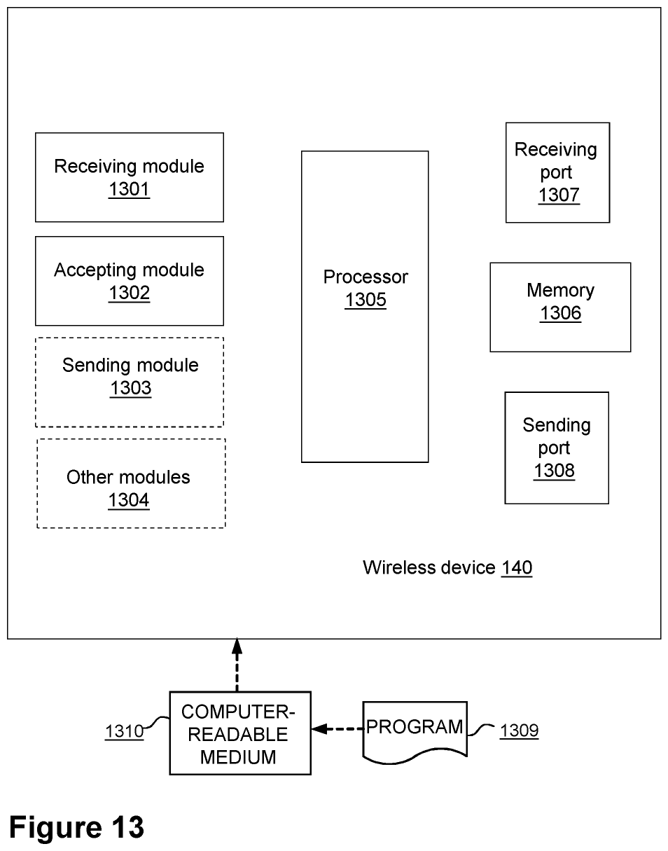

To perform the method actions described above in relation to FIG. 2, FIG. 4-6, and FIG. 7, the wireless device 140 may comprise the following arrangement depicted in FIG. 13. The wireless device 140 is configured to operate in the wireless communications network 100. The wireless device 140 is configured to be handled by the first core network node 101 configured to operate in the wireless communications network 100.

The detailed description of some of the following corresponds to the same references provided above, in relation to the actions described for the wireless device 140, and will thus not be repeated here. For example, the first message may be a NAS message.

It should be noted that the examples herein are not mutually exclusive. Components from one example may be tacitly assumed to be present in another example and it will be obvious to a person skilled in the art how those components may be used in the other examples. In FIG. 13, optional modules are indicated with dashed boxes.

The wireless device 140 may be configured to perform the receiving action 602, e.g. by means of a receiving module 1301 within the wireless device 140 configured to, receive the third message from the radio network node 110 based on the second message configured to be sent from the second core network node 102. The second core network node 102 and the radio network node 110 are configured to operate in the wireless communications network 100. The receiving of the third message is configured to be performed in the absence of the requirement for signalling from the wireless device 140. The receiving module 1301 may be a processor 1305 of the wireless device 140, or an application running on such processor.

The wireless device 140 may be configured to perform the accepting 603 action, e.g. by means of an accepting module 1302 within the wireless device 140 configured to, accept registration with second core network node 102, based on the third message configured to be received. The accepting module 1302 may be the processor 1305 of the wireless device 140, or an application running on such processor.

The wireless device 140 may be configured to perform the sending action 601, e.g. by means a sending module 1303 within the wireless device 140 configured to, send the first message to the first core network node 101 via the radio network node 110. The first message may be configured to comprise the third identifier configured to temporarily identify the wireless device 140 in association with the first core network node 101. The third message may be associated with the sixth identifier configured to temporarily identify the wireless device 140 in association with the second core network node 102. The sending module 1303 may be the processor 1305 of the wireless device 140, or an application running on such processor.

Other modules 1304 may be comprised in the wireless device 140.

The embodiments herein may be implemented through one or more processors, such as a processor 1305 in the wireless device 140 depicted in FIG. 13, together with computer program code for performing the functions and actions of the embodiments herein. The program code mentioned above may also be provided as a computer program product, for instance in the form of a data carrier carrying computer program code for performing the embodiments herein when being loaded into the in the wireless device 140. One such carrier may be in the form of a CD ROM disc. It is however feasible with other data carriers such as a memory stick. The computer program code may furthermore be provided as pure program code on a server and downloaded to the wireless device 140.

The wireless device 140 may further comprise a memory 1306 comprising one or more memory units. The memory 1306 is arranged to be used to store obtained information, store data, configurations, schedulings, and applications etc. to perform the methods herein when being executed in the wireless device 140.

In some embodiments, the wireless device 140 may receive information from the radio network node 110, the first core network node 101, the second core network node 102, through a receiving port 1307. In some embodiments, the receiving port 1307 may be, for example, connected to one or more antennas in wireless device 140. In other embodiments, the wireless device 140 may receive information from another structure in the wireless communications network 100 through the receiving port 1307. Since the receiving port 1307 may be in communication with the processor 1305, the receiving port 1307 may then send the received information to the processor 1305. The receiving port 1307 may also be configured to receive other information.

The processor 1305 in the wireless device 140 may be further configured to transmit or send information to e.g., first core network node 101, the second core network node 102 and/or the radio network node 110, through a sending port 1308, which may be in communication with the processor 1305, and the memory 1306.

Those skilled in the art will also appreciate that the receiving module 1301, the accepting module 1302, the sending module 1303, and the other modules 1304 described above may refer to a combination of analog and digital modules, and/or one or more processors configured with software and/or firmware, e.g., stored in memory, that, when executed by the one or more processors such as the processor 1305, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different modules 1301-1304 described above may be implemented as one or more applications running on one or more processors such as the processor 1305.

Thus, the methods according to the embodiments described herein for the wireless device 140 may be respectively implemented by means of a computer program 1309 product, comprising instructions, i.e., software code portions, which, when executed on at least one processor 1305, cause the at least one processor 1305 to carry out the actions described herein, as performed by the wireless device 140. The computer program 1309 product may be stored on a computer-readable storage medium 1310. The computer-readable storage medium 1310, having stored thereon the computer program 1309, may comprise instructions which, when executed on at least one processor 1305, cause the at least one processor 1305 to carry out the actions described herein, as performed by the wireless device 140. In some embodiments, the computer-readable storage medium 1310 may be a non-transitory computer-readable storage medium, such as a CD ROM disc, a memory stick, or stored in the cloud space. In other embodiments, the computer program 1309 product may be stored on a carrier containing the computer program, wherein the carrier is one of an electronic signal, optical signal, radio signal, or the computer-readable storage medium 1310, as described above.

The wireless device 140 may comprise an interface unit to facilitate communications between the wireless device 140 and other nodes or devices, e.g., the first core network node 101, the second core network node 102, the radio network node 110, or any of the other nodes. In some particular examples, the interface may, for example, include a transceiver configured to transmit and receive radio signals over an air interface in accordance with a suitable standard.

When using the word “comprise” or “comprising” it shall be interpreted as non-limiting, i.e. meaning “consist at least of”.

The term module may be understood herein as being equivalent to the term unit.

The term processor may be understood to refer to a hardware component, e.g., a processing circuit.

The embodiments herein are not limited to the above described preferred embodiments. Various alternatives, modifications and equivalents may be used. Therefore, the above embodiments should not be taken as limiting the scope of the invention.

1.-35. (canceled).

36. A method performed by a first core network node operating in a wireless communications network, the method comprising:
sending first information, relating to a wireless device registered with or managed by the first core network node, to a second core network node operating in the wireless communications network, wherein:
the first information is sent without a request from the second core network node to obtain the first information, and
the first information initiates registration of the wireless device with the second core network node.

37. The method according to claim 36, wherein the first information is a Mobility Management and Evolved Packet System (EPS) Context of a User Equipment (UE).

38. The method according to claim 36, wherein the first information comprises at least one of the following:
a first identifier identifying a radio network node serving the wireless device;
a second identifier identifying the wireless device in a radio access network (RAN);
a third identifier temporarily identifying the wireless device in association with the first core network node;
a fourth identifier identifying the first core network node; and
a fifth identifier identifying the first core network node in the first core network.

39. The method according to claim 36, wherein the sending is performed independently of receiving a first message from the wireless device.

40. The method according to claim 36, wherein the sending is performed based on receiving a first message from the wireless device.

41. The method according to claim 40, wherein the first message is a Non-Access Stratum (NAS) message.

42. The method according to claim 40, further comprising:
receiving the first message, from the wireless device, via a radio network node that operates in the wireless communication network and serves the wireless device, wherein the first message includes a third identifier that temporarily identifies the wireless device; and
forwarding, to the second core network node, the received first message and any other messages received from the wireless device via the radio network node.

43. The method according to claim 42, further comprising:
receiving an indication to cancel the forwarding of the received first message and any other messages received from the wireless device via the radio network node, and
clearing the first information associated with the wireless device, based on the received

44. A method performed by a wireless device registered with or managed by a first core network node operating in a wireless communications network, the method comprising:
receiving a third message from a radio network node in the wireless communication network, based on a second message sent from a second core network node in the wireless communication network, wherein the third message is received without a requirement for signalling from the wireless device; and
based on the received third message, accepting registration with second core network node.

45. A first core network node configured to operate in a wireless communications network, the first core network node comprising:
one or more communication ports configured to communicate with:
a wireless device registered with or managed by the first core network node, and
a second core network node in the wireless communications network; and
one or more processors operably coupled to the communication ports, whereby the processors and the communication ports are configured to:
send first information, relating to the wireless device, to the second core network node, wherein:
the first information is sent without a request from the second core network node to obtain the first information, and
the first information initiates registration of the wireless device with the second core network node.

46. A wireless device configured to operate in a wireless communications network, based on being registered with or managed by a first core network node in the wireless communications network, the wireless device comprising:
one or more communication ports configured to communicate with at least the first core network node via a radio network node in the wireless communication network; and
one or more processors operably coupled to the communication ports, whereby the processors and the communication ports are configured to:
receive a third message from the radio network node based on a second message sent from a second core network node in the wireless communication network, wherein the third message is received without a requirement for signalling from the wireless device; and
based on the third message configured to be received, accept registration with second core network node.
